(19) United States
(12) Patent Application Publication
(10) Pub. No.: US 2006/0143402 A1
(43) Pub. Date: Jun. 29, 2006

(54) Mechanism for processing uncacheable streaming data

(76) Inventors: Srinivas Chennupaty, Portland, OR (US); Jack Doweck, Haifa (IL); Blaise Fanning, El Dorado Hills, CA (US); Prashant Sethi, Folsom, CA (US); Opher Kahn, Zichron (IL)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/021,662

(22) Filed: Dec. 23, 2004

(51) Int. Cl. G06F 13/00

(52) U.S. Cl. 711/141

(57) ABSTRACT

In one embodiment, a buffer is presented. The buffer comprises a type designator to designate that the buffer is a streaming read buffer, and a plurality of use designators to indicate whether data within the buffer has been used. The data within the buffer is an uncacheable memory type, such as Uncacheable Speculative Write Combining (USWC) memory. Furthermore, in some embodiments, the buffer is allocated upon execution of a streaming read buffer instruction. In other embodiments, the data within the buffer can only be used once and cannot be cached elsewhere in the processor.

### FIELD OF THE INVENTION

The present embodiments of the invention relate generally to processors and, more specifically, relate to processors using an uncacheable memory type for reads and writes to memory.

### BACKGROUND

Media adapters connected to the input/output space in a computer system generate isochronous traffic that results in high-bandwidth direct memory access (DMA) writes to main memory. Because the snoop response in modern processors can be unbounded, and because of the requirements for isochronous traffic, systems are forced to use an uncacheable memory type for these transactions to avoid snoops to the processor. Such snoops to the processor can slow down a processor and interfere with its processing capabilities.

Uncacheable memory types include memory types such as Uncacheable Speculative Write Combining (USWC) memory and Uncacheable (UC) memory. These memory types are defined and allocated by the processor. Any access to the data of these memory types may not be cached in the processor. Use of uncacheable memory types avoids snoops to the processor by other processors and devices, which can interfere with the processor's own functions and throughput.

Since media data is usually non-temporal in nature, it is not desirable to use cacheable memory for such operations, as this will create unnecessary cache pollution. But, processing the media data by the processor, using the UC memory type results in low processing bandwidth and high latency. The effective throughput of the media data is limited by the processor, and is likely to become a limiting factor in the ability of future systems to deal with high-bandwidth isochronous media processing, such as processing of video data. In some processors, the latency can be slightly improved by using the USWC memory type.

Increasing the bandwidth and lowering the latency of the uncacheable memory types, while still preserving their uncacheable behavior, would greatly benefit the throughput of high-bandwidth, isochronous media data in a processor.

### BRIEF DESCRIPTION OF THE DRAWINGS

The present invention will be understood more fully from the detailed description given below and from the accompanying drawings of various embodiments of the invention. The drawings, however, should not be taken to limit the invention to the specific embodiments, but are for explanation and understanding only.

FIG. 1 illustrates a block diagram of a computer system;

FIG. 2 illustrates a block diagram of a processor;

FIG. 3 illustrates a block diagram of a Level 1 cache;

FIG. 4 is a flow diagram of possible actions to invalidate a Streaming Read Buffer; and

FIG. 5 depicts a flow diagram for an embodiment of one method to execute a Streaming Read Buffer instruction.

### DETAILED DESCRIPTION

A method and apparatus for processing uncacheable streaming data is described. Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some embodiments of the present invention are implemented in a machine-accessible medium. A machine-accessible medium includes any mechanism that provides (i.e., stores and/or transmits) information in a form accessible by a machine (e.g., a computer, network device, personal digital assistant, manufacturing tool, any device with a set of one or more processors, etc.). For example, a machine-accessible medium includes recordable/non-recordable media (e.g., read only memory (ROM); random access memory (RAM); magnetic disk storage media; optical storage media; flash memory devices; etc.), as well as electrical, optical, acoustical or other form of propagated signals (e.g., carrier waves, infrared signals, digital signals, etc.); etc.

In the following description, numerous details are set forth. It will be apparent, however, to one skilled in the art, that the embodiments of the invention may be practiced without these specific details. In other instances, well-known structures and devices are shown in block diagram form, rather than in detail, in order to avoid obscuring the present invention.

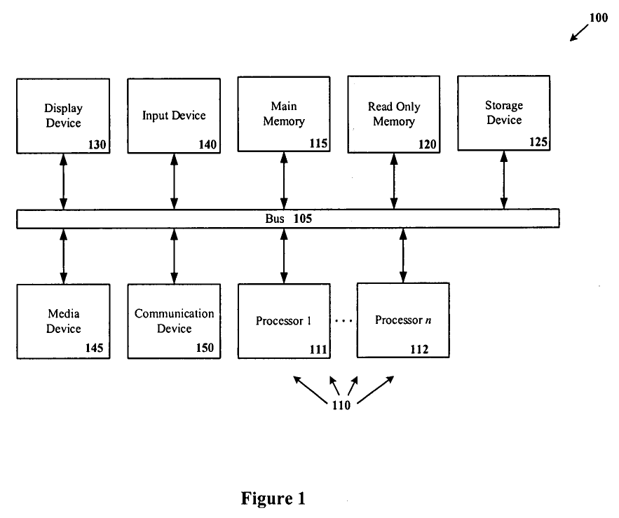

FIG. 1 illustrates an embodiment of an exemplary computer environment. Under an embodiment of the invention, a computer 100 comprises a bus 105 or other communication means for communicating information, and a processing means such as one or more processors 110 (shown as 111 through 112) coupled with the first bus 105 for processing information.

The computer 100 further comprises a random access memory (RAM) or other dynamic storage device as a main memory 115 for storing information and instructions to be executed by the processors 110. Main memory 115 also may be used for storing temporary variables or other intermediate information during execution of instructions by the processors 110. The computer 100 also may comprise a read only memory (ROM) 120 and/or other static storage device for storing static information and instructions for the processor 110.

A data storage device 125 may also be coupled to the bus 105 of the computer 100 for storing information and instructions. The data storage device 125 may include a magnetic disk or optical disc and its corresponding drive, flash memory or other nonvolatile memory, or other memory device. Such elements may be combined together or may be separate components, and utilize parts of other elements of the computer 100.

The computer 100 may also be coupled via the bus 105 to a display device 130, such as a liquid crystal display (LCD) or other display technology, for displaying information to an end user. In some environments, the display device may be a touch-screen that is also utilized as at least a part of an input device. In some environments, display device 130 may be or may include an auditory device, such as a speaker for providing auditory information.

An input device 140 may be coupled to the bus 105 for communicating information and/or command selections to the processor 110. In various implementations, input device 140 may be a keyboard, a keypad, a touch-screen and stylus, a voice-activated system, or other input device, or combinations of such devices.

Another type of device that may be included is a media device 145, such as a device utilizing video, or other high-bandwidth requirements. The media device 145 communicates with the processor 110, and may further generate its results on the display device 130.

A communication device 150 may also be coupled to the bus 105. Depending upon the particular implementation, the communication device 150 may include a transceiver, a wireless modem, a network interface card, or other interface device. The computer 100 may be linked to a network or to other devices using the communication device 150, which may include links to the Internet, a local area network, or another environment. In an embodiment of the invention, the communication device 150 may provide a link to a service provider over a network.

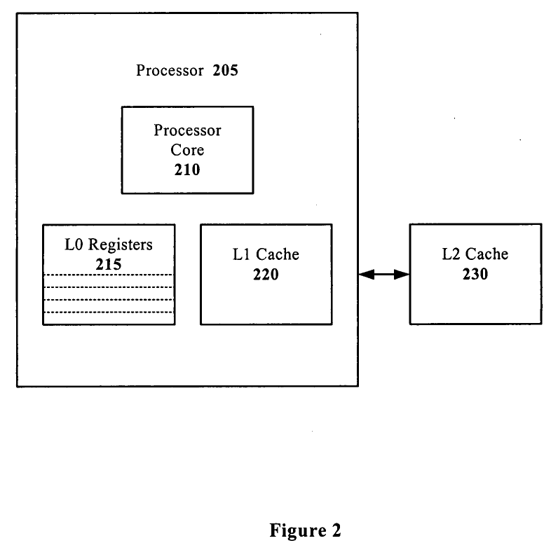

FIG. 2 illustrates an embodiment of a microprocessor utilizing a cache memory. A processor (or CPU) 205 is included, and may be implemented as one of processors 110 in FIG. 1. In one embodiment, processor 205 is a processor in the Pentium® family of processors including the Pentium® II processor family, Pentium® III processors, Pentium® IV processors, and Pentium-M™ processors available from Intel Corporation of Santa Clara, Calif. Alternatively, other processors may be used. In this illustration, a processor 205 includes a processor core 210 for processing of operations and one or more cache memories. The cache memories may be structured in various different ways.

Using common terminology for cache memories, the illustration shown in FIG. 2 includes a Level 0 (L0) memory 215 that comprises a plurality of registers. Included on the processor 205 is a Level 1 (L1) cache 220 to provide very fast data access. Coupled to processor 205 is a Level 2 (L2) cache 230, which generally will be larger than but not as fast as the L1 cache 220. In other embodiments the L2 cache 230 may be separate from the processor. In some embodiments, the system may include other cache memories.

Embodiments of the present invention allow the processor 205 to read uncacheable streaming data at a high throughput (the same throughput as reading cacheable data) without violating the uncacheability requirements. Uncacheable streaming data includes the Uncacheable Speculative Write Combining (USWC) memory type. Uncacheable memory types are not cached in the processor, and thus the data is only used once when accessed from memory. Embodiments of the invention also allow the processor 205 to read non-temporal streaming data without polluting the cache.

Embodiments of the present invention utilize the USWC memory type, but other embodiments are not precluded from the possibility of utilizing any other memory type to accomplish a particular objective. For example, although the Uncacheable (UC) memory type is non-speculatable, some embodiments of the present invention may employ this memory type.

Embodiments of the invention consist of two tightly coupled components:

(1) Streaming Read Buffer: A hardware mechanism that allows the processor to generate a cache-line-wide read request to uncacheable streaming memory (such as USWC), place the data in a buffer, and supply the data to the program while maintaining conventional uncacheability behavior.

(2) An instruction or other software visible mean to activate the streaming read buffer mechanism.

The Streaming Read Buffer:

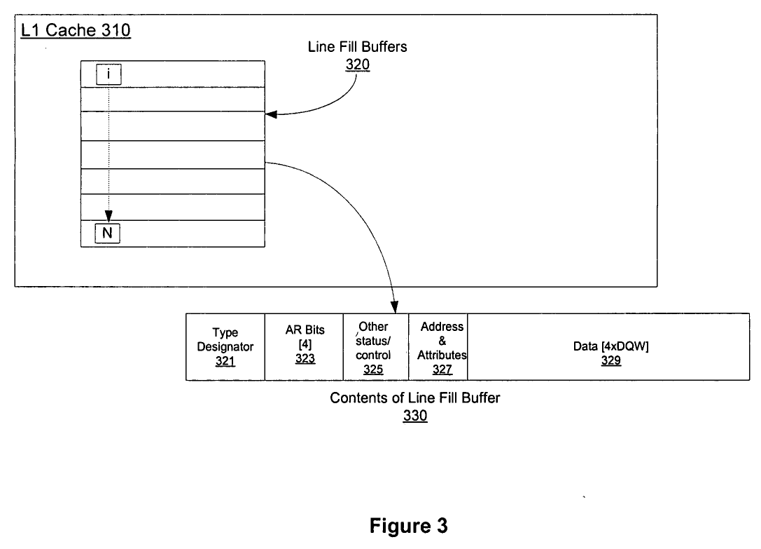

FIG. 3 depicts a high-level block diagram of the relevant logic in the L1 cache 310 of a processor. In some embodiments, L1 cache 310 may be L1 cache 220 of FIG. 2. FIG. 3 highlights the implementation of a Streaming Read Buffer. A structure of Line Fill Buffers (LFB) 320 is located in the L1 cache 310. The number of LFBs 320 allocated is implementation specific. As shown in FIG. 3, there are up to ‘N’ LFBs. A LFB entry 320(i) is used for temporary storage of address, data, controls, and various status of any type of outstanding request to the L2 cache or bus.

The contents 330 of the LFB entry are illustrated in FIG. 3. The LFB entry 320(i) may include a type designator 321, AR bits 323, other status and control indicators 325, address and attributes 327, and data 329.

In embodiments of the present invention, the new Streaming Read Buffer (SRB) may be implemented in the already existing LFB structure 320 of the L1 cache 310. The conventional LFB structure 320 in the L1 cache 310 is enhanced by a new SRB type designator 321. This type designator 321 is added to the structure to indicate that an entry is allocated to a request originated by a special SRB instruction (discussed infra) to a particular memory type, such as USWC. Furthermore, the LFB structure 320 is enhanced by a new status bit (AR bit) 323 indicating if certain data within the SRB was already read (AR).

In other embodiments, the SRB may be implemented as a separate, individual structure in the L1 cache 310. In one embodiment, the SRB is not required to be implemented in the already-existing LFB structure 320. One skilled in the art will appreciate that there may be various implementations of the SRB structure

In one embodiment, the SRB maintains coherency and uncacheability of the memory type it is storing. In another embodiment, a SRB is invalidated, flushed, and, if necessary, the proper request is reissued to refetch the data from external memory, if any of the following conditions occur:
A load instruction other than a SRB instruction accesses the same memory location (“hits”) as what is currently stored in a SRB
A SRB instruction hits a SRB with the corresponding AR bit set
A store instruction hits a SRB
A snoop hits a SRB (the processor should not answer the hit)
All the AR bits are set
Execution of a fencing operation instruction
Other implementation specific conditions (e.g., a new LFB needs to be allocated and there are no free entries)

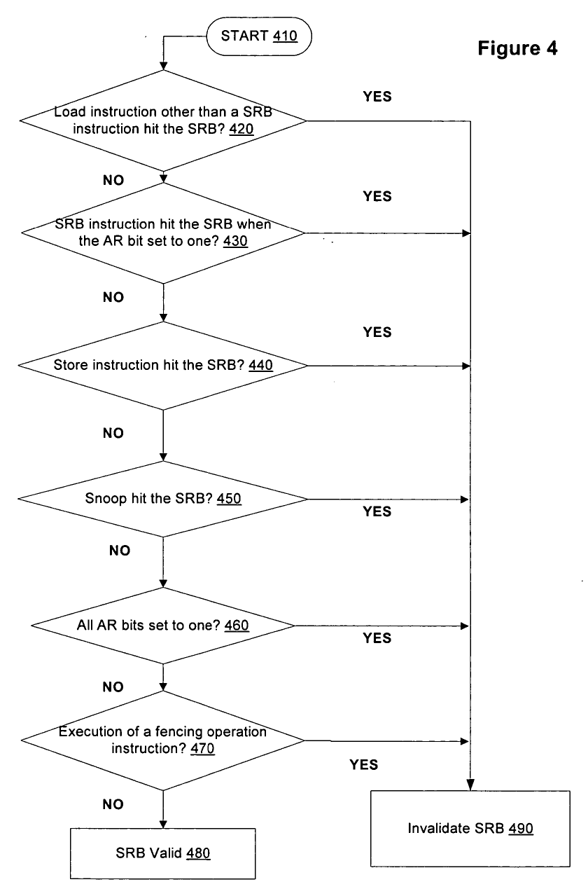

FIG. 4 is a flow diagram of one embodiment of a process for invalidating a SRB. The process begins at start block 410. At decision block 420, the processor determines whether a load instruction other than a streaming read buffer hit the SRB. If not, then the process continues to decision block 430, where the processor determines whether an SRB instruction hits the SRB when the AR bit for the particular data was set to one. If not, then the process continues to decision block 440, where the processor determines whether a store instruction hit the SRB.

If not, the process continues at decision block 450, where the processor determines whether a snoop hit the SRB. If not, the process continues at decision block 460, where the processor determines whether all of the AR bits in the SRB are set to one. If not the process continues at decision block 470, where the processor determines whether a fencing operation instruction has been executed. If not, then at processing block 480 the processor determines the SRB to be valid. If at any of decision blocks 420-470 the answer had been yes, then the process would continue to processing block 490, where the processor determines the SRB to be invalid.

One embodiment of the invention will mark the SRB entry invalid if any one of the above conditions occurs. Other embodiments may only mark an SRB entry invalid if one of only a subset of the above conditions occurred. One skilled in the art will appreciate that the above conditions may be altered to achieve a particular desired objective. One skilled in the art will also appreciate that the above conditions can be evaluated in parallel and not sequentially as described above.

When a SRB is flushed it is marked as invalid, but the LFB entry on which it resides is deallocated only after all data has arrived. If a SRB is invalidated for any reason, a new SRB instruction to that line will reissue a new line read to external memory. No pre-defined addressing order is required between multiple SRB instructions to the same line.

The SRB Instruction:

In one embodiment, a SRB instruction forces a cache-line-wide read of the line containing the desired memory location to be accessed. In one embodiment, the SRB instruction is a regular load instruction with a SRB hint. The SRB instruction is implemented with uncacheable memory types, such as USWC. In one embodiment, if the memory type being accessed is not of the uncacheable type, then the SRB hint has no effect and the instruction is treated as a regular load instruction of the same category.

Furthermore, in some embodiments, the SRB instruction is implemented as a hint that does not have to be implemented every time. Instead, the processor may revert to the old behavior of a regular uncacheable load. In some embodiments, the implementation of the SRB hint is processor-dependent, and can be ignored by a particular processor implementation. The amount of data prefetched is also processor implementation-dependent, but limited, in one embodiment, to the size of a cache line.

The first time the SRB instruction is executed it allocates an SRB in the LFB structure 320 and issues a cache-line-wide read request to the bus. The read request includes the requested data, plus any other data included on the line containing the memory location. For example, in some processors, a cache-line-wide request for 16 bytes of data with the SRB instruction may return 64 bytes of data (including the 16 bytes desired).

In one embodiment, upon the SRB allocation, all of the AR bits in the SRB entry are cleared to indicate that the data designated by the particular AR bit was not read yet. In this embodiment, the SRB internally prevents caching of the returning data in any cache level, or activation of any hardware prefetcher. The execution of the SRB instruction forces the uncacheable data into the SRB while keeping the uncacheable semantics of the memory type. The uncacheable semantics include not allowing the line to be cached anywhere, and not allowing each datum in the line to be used more than once.

When the data specified in the SRB instruction is available, the data value is stored in a specified register, and its corresponding AR bit in the SRB is set to indicate this particular datum was already used. The rest of the data coming from the bus is placed in the SRB. When a SRB instruction hits a SRB already allocated and the data is available with its AR bit cleared, the datum is extracted from the SRB and written back to the register and the corresponding AR bit is set.

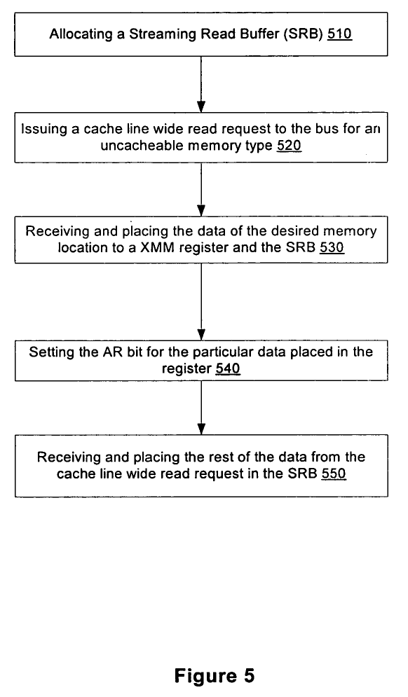

FIG. 5 is a flow diagram depicting one embodiment of a method of processing the SRB instruction. In one embodiment, software within the computer system may issue the SRB instruction. At processing block 510, upon execution of the SRB instruction the processor allocates a SRB. At processing block 520, the processor issues a cache-line-wide read request to the bus for the line of uncacheable memory containing the desired data to be retrieved. Then, at processing block 530, the processor receives the data from the desired memory location and places it in a register and in the SRB. Then, at processing block 540, the processor sets to one the AR bit for that particular data placed in the register. The processor places the rest of the data from the cache-line-wide read request in the SRB at processing block 550.

The SRB instruction is intended for processing data generated by a device or processor that produces sequential writes to uncacheable memory types, such as USWC. Software provides proper synchronization prior to use of this instruction to ensure that all the data residing in the cache line was already written by the generating agent. In one embodiment, a fencing operation is used after a series of SRB instructions to ensure that future reads will observe subsequent writes by other processors or devices.

In one embodiment of the present invention, the streaming read buffer and SRB instruction may be implemented in a processor with an IA-32 instruction set and Pentium-M™ like micro-architecture. The SRB instruction may be implemented as a MOVDQASR xmm1, m128 (Move Aligned Double Quadword using Streaming Read hint) instruction. The MOVDQASR instruction moves the double quadword in the source operand (second operand m128) to the destination operand (first operand xmm1). The destination operand is an XMM register. The source operand is an aligned 128-bit memory location.

When the MOVDQASR instruction is executed, a SRB entry is allocated in the LFB structure with the AR bits cleared. A 64-byte read request is issued to the bus, with the read request including an attribute that internally prevents caching of the returning data to any cache level or activation of any hardware prefetcher. Each AR bit in the allocated SRB entry is associated with a particular double quadword of the 64-byte read request to memory, so that there are 4 AR bits in total.

When the double quadword specified in the instruction is available on the bus, the value is stored in the XMM register and the corresponding AR bit in the SRB is set to indicate this particular datum was used. The rest of the data (48 bytes) and the data already placed in the XMM register is placed in the allocated SRB. The SRB entry should follow the coherency and uncacheability rules mentioned above with respect to the SRB and SRB instruction description.

Many media adapters and processors use uncacheable memory types, such as USWC, for certain media data transactions. Media devices issue line-wide DMA writes to uncacheable memory type to fill a data buffer, and invoke a software routine via an interrupt or other proper synchronization method. The software routine is invoked to either copy the data to write back (WB) memory or to process the data buffer directly. The software routine may make heavy usage of the new SRB instruction to improve throughput.

Software may also utilize this SRB instruction for high-performance reads of large amounts of non-temporal data without polluting the processor cache. For example, a video capture application may utilize this operation to read high-bandwidth video data from a TV tuner device such that the non-temporal video data does not unnecessarily pollute the processor cache.

In alternative embodiments, a new Uncacheable Speculatable Streaming Read memory type may be created to produce the same results as the SRB and SRB instruction.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as the invention.

What is claimed is:

1. An apparatus, comprising:
a buffer including
a type designator to designate that the buffer is a streaming read buffer; and
a plurality of use designators to indicate whether data within the buffer has been used,
wherein the data within the buffer is an uncacheable memory type.

2. The apparatus of claim 1, wherein the buffer is allocated upon execution of a streaming read buffer instruction.

3. The apparatus of claim 1, wherein the uncacheable memory type is Uncacheable Speculative Write Combining (USWC) memory.

4. The apparatus of claim 1, wherein the data within the buffer is usable only once.

5. The apparatus of claim 4, wherein one of the plurality of use designators is modified once a portion of the data within the buffer is used.

6. The apparatus of claim 1, wherein the buffer is indicated as invalid if at least one of the following occur:
a load instruction other than a streaming read buffer instruction accesses the same memory location as the memory location of the data in the buffer;
a streaming read buffer instruction hits the buffer with one of the plurality of the use designators indicating that the data has been used;
a store instruction accesses data in the buffer;
a snoop accesses data in the buffer;
the plurality of use designators indicate that all of the data within the buffer has been used; and
execution of a fencing operation instruction.

7. The apparatus of claim 1, wherein the buffer is located in a line fill buffer of a cache in a processor.

8. The apparatus of claim 1, wherein the buffer further comprises:
a status storage area to identify status and control attributes of the data within the buffer;
an address storage area to identify address information of the data within the buffer; and
a data storage area to store the data of the buffer.

9. The apparatus of claim 1, wherein the data within the buffer is not allowed to be cached.

10. A method, comprising:
allocating a buffer;
issuing a cache-line-wide read request to a bus for an uncacheable memory type;
placing data received from the bus into a register and into the buffer;
setting a designator for the data placed in the register to indicate that the data was used; and
placing the rest of the data from the cache-line-wide read request into the buffer.

11. The method of claim 10, wherein a type designator in the buffer indicates that the buffer is a streaming read buffer.

12. The method of claim 10, wherein the data in the buffer is usable only once.

13. The method of claim 10, further comprising indicating that the buffer is invalid if at least one of the following occur:
a load instruction other than a streaming read buffer instruction accesses the same memory location as the memory location of data in the buffer;
a streaming read buffer instruction accesses data in the buffer when one of a plurality of use designators of the buffer indicates that the data has been used;
a store instruction accesses data in the buffer;
a snoop accesses data in the buffer;
the plurality of use designators indicate that all of the data within the buffer has been used; and
execution of a fencing operation instruction.

14. The method of claim 10, wherein if the data within the buffer is not allowed to be cached.

15. A system, comprising:
SDRAM;
a media device connected to the SDRAM by a bus; and
a processor connected to the SDRAM and the media device by the bus, and further comprising a buffer including
a type designator to designate that the buffer is a streaming read buffer; and
a plurality of use designators to indicate whether data within the buffer has been used,
wherein the data within the buffer is an uncacheable memory type.

16. The system of claim 15, wherein the buffer is allocated upon execution of a streaming read buffer instruction.

17. The system of claim 15, wherein the uncacheable memory type is Uncacheable Speculative Write Combining (USWC) memory.

18. The system of claim 15, wherein the data within the buffer is usable only once.

19. The system of claim 18, wherein one of the plurality of use designators is modified once a portion of the data within the buffer is used.

20. The system of claim 15, wherein the buffer is located in a line fill buffer of cache in a processor.

21. The system of claim 15, wherein the buffer is indicated as invalid if at least one of the following occur:
a load instruction other than a streaming read buffer instruction accesses a same memory location as a memory location of data in the buffer;
a streaming read buffer instruction accesses data in the buffer with one of the plurality of use designators indicating that the data has been used;
a store instruction accesses data in the buffer;
a snoop accesses data in the buffer;
the plurality of use designators indicate that all of the data within the buffer has been used; and
execution of a fencing operation instruction.

22. The system of claim 15, further comprising:
a status storage area to identify status and control attributes of the data within the buffer;
an address storage area to identify address information of the data within the buffer; and
a data storage area to store the data of the buffer.

23. An article of manufacture comprising:
a machine-accessible medium including data that, when accessed by a machine, cause the machine to perform operations comprising,
allocating a buffer;
issuing a cache-line-wide read request to a bus for an uncacheable memory type;
placing data received from the bus into a register and into the buffer;
setting a designator for the data placed in the register to indicate that the data was used; and
placing the rest of the data from the cache-line-wide read request into the buffer.

24. The article of manufacture of claim 23, wherein a type designator in the buffer indicates that the buffer is a streaming read buffer.

25. The article of manufacture of claim 23, the machine-accessible medium further includes data that cause the machine to perform operations comprising:
indicating that the buffer is invalid if at least one of the following occur:
a load instruction other than a streaming read buffer instruction accesses the same memory location as the memory location of data in the buffer;
a streaming read buffer instruction accesses data in the buffer when one of a plurality of use designators of the buffer indicates that the data has been used;
a store instruction accesses data in the buffer;
a snoop accesses data in the buffer;
the plurality of use designators indicate that all of the data within the buffer has been used; and
execution of a fencing operation instruction.
